(19) United States
(12) Patent Application Publication
(10) Pub. No.: US 2025/0347814 A1
(43) Pub. Date: Nov. 13, 2025

(54) X-RAY IMAGING DEVICE

(71) Applicant: Sharp Display Technology Corporation, Kameyama City (JP)

(72) Inventor: Kozo TAKAHASHI, Kameyama City (JP)

(21) Appl. No.: 19/193,056

(22) Filed: Apr. 29, 2025

(30) Foreign Application Priority Data
May 10, 2024 (JP) 2024-077530

(51) Int. Cl. G01T 1/20

(52) U.S. Cl. CPC G01T 1/20184

(57) ABSTRACT

An X-ray imaging device includes a normally-off TFT, a gate line, a gate drive circuit including an output line, a switch connected between the gate line and the output line, and a control circuit. The control circuit operates the switch to switch from a state in which the gate line and the output line are connected to each other to a state in which the gate line and the output line are disconnected from each other in at least part of a period during which X-rays are not emitted from the X-ray source.

### CROSS-REFERENCE TO RELATED APPLICATIONS

This application claims the benefit of priority to Japanese Patent Application Number 2024-077530 filed on May 10, 2024. The entire contents of the above-identified application are hereby incorporated by reference.

### BACKGROUND

### Technical Field

The disclosure relates to an X-ray imaging device.

The radiation image detection device disclosed in JP 2011-216723 A includes a phosphor layer that converts incident radiation into visible light, an organic photoelectric conversion layer that converts visible light into an electric signal, a normally-on thin film transistor that is turned off when a gate voltage is supplied, a storage capacitor, and a control unit. The control unit applies 0 V to a gate electrode of the thin film transistor in an imaging preparation period before imaging. By applying 0 V to the gate electrode of the normally-on thin film transistor, the thin film transistor can be brought into a state close to a conduction state between a source and a drain. Thus, a dark current generated when a bias voltage is applied to a bias electrode of the organic photoelectric conversion layer is discharged through the thin film transistor, and the dark current is prevented from being stored in the storage capacitor. Since the applied gate voltage is 0 V, a threshold shift of the thin film transistor is less likely to occur than in the case where a voltage other than 0 V is applied.

### SUMMARY

In the radiation image detection device disclosed in JP 2011-216723 A, the occurrence of the threshold shift is prevented, but the thin film transistor is configured to be normally-on in order to conduct between the source and the drain at 0 V. Thus, the technique disclosed in JP 2011-216723 A cannot be applied to a radiation image detection device (X-ray imaging device) including a normally-off thin film transistor. The normally-off thin film transistor does not conduct between the source and the drain at 0 V, and is turned on when a gate signal having a voltage equal to or higher than a threshold voltage is applied to the gate electrode.

Thus, the disclosure has been conceived in order to solve the problems described above and aims to provide an X-ray imaging device that can reduce a threshold shift even when the X-ray imaging device includes the normally-off thin film transistor and the threshold shift occurs.

In order to solve the problems described above, an X-ray imaging device according to a first aspect of the disclosure includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode, a gate line connected to the gate electrode, a gate drive circuit configured to supply the gate signal to the gate line, the gate drive circuit including an output line configured to output the gate signal, a switch connected between the gate line and the output line, and a control circuit configured to control an operation of the switch. The control circuit operates the switch to switch from a state in which the gate line and the output line are connected to each other to a state in which the gate line is connected to a ground in a first period that is at least part of a period during which X-rays are not emitted from the X-ray source, or to switch from the state in which the gate line and the output line are connected to each other to a state in which the gate line and the output line are disconnected from each other in the first period.

An X-ray imaging device according to a second aspect includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode, a gate line connected to the gate electrode, a gate drive circuit configured to supply the gate signal to the gate line, the gate drive circuit including an input line to which a gate-off voltage that is a voltage less than the threshold voltage is input, a gate-off voltage line configured to supply a gate-off voltage that is a voltage less than the threshold voltage to the input line, a switch connected between the gate-off voltage line and the input line, and a control circuit configured to control an operation of the gate drive circuit and an operation of the switch. The control circuit operates the switch to switch from a state in which the gate-off voltage line and the input line are connected to each other to a state in which the input line is connected to the ground in a second period that is at least part of a period during which X-rays are not emitted from the X-ray source, or to switch from the state in which the gate-off voltage line and the input line are connected to each other to a state in which the gate-off voltage line and the input line are disconnected from each other in the second period.

An X-ray imaging device according to a third aspect includes, a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode of the thin film transistor, a gate line connected to the gate electrode, a gate drive circuit including a shift register configured to output the gate signal, and a switch connected between the shift register and the gate line, and a control circuit configured to control an operation of the gate drive circuit. The control circuit operates the switch to switch from a state in which the shift register and the gate line are connected to each other to a state in which the gate line is connected to a ground in a third period that is at least part of a period during which X-rays are not emitted from the X-ray source, or to switch from the state in which the shift register and the gate line are connected to each other to a state in which the shift register and the gate line are disconnected from each other in the third period.

An X-ray imaging device according to a fourth aspect includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode of the thin film transistor, a gate line connected to the gate electrode, a gate-off voltage line configured to supply a gate-off voltage that is a voltage less than the threshold voltage, a gate drive circuit including a shift register configured to output the gate signal and a switch connected between the shift register and the gate-off voltage line, and a control circuit configured to control an operation of the gate drive circuit. The control circuit operates the switch to switch from a state in which the shift register and the gate-off voltage line are connected to each other to a state in which the shift register is connected to a ground in a fourth period that is at least part of a period during which X-rays are not emitted from the X-ray source, or to switch from the state in which the shift register and the gate-off voltage line are connected to each other to a state in which the shift register and the gate-off voltage line are disconnected from each other in the fourth period.

According to the above configuration, even when the normally-off thin film transistor is included and the threshold shift occurs, the threshold shift can be reduced.

### BRIEF DESCRIPTION OF DRAWINGS

The disclosure will be described with reference to the accompanying drawings, wherein like numbers reference like elements.

FIG. 1 is a schematic view illustrating an X-ray imaging device 100 according to a first embodiment.

FIG. 2 is a schematic circuit diagram of the X-ray imaging device 100 according to the first embodiment.

FIG. 3 is a schematic circuit diagram of the X-ray imaging device 100 according to the first embodiment.

FIG. 4 is a diagram for describing a period T1 during which X-rays are emitted and an operation timing of a switch 21 according to the first embodiment.

FIG. 5 is a view illustrating a configuration of an X-ray imaging device 200 according to a second embodiment.

FIG. 6 is a diagram illustrating a configuration of a photoelectric conversion panel 201 according to the second embodiment.

FIG. 7 is a view illustrating a configuration of an X-ray imaging device 300 according to a third embodiment.

FIG. 8 is a diagram illustrating a configuration of a photoelectric conversion panel 301 according to the third embodiment.

FIG. 9 is a diagram illustrating a configuration of an X-ray imaging device 400 according to a first modified example of the third embodiment.

FIG. 10 is measurement results of a threshold value of a TFT 12 of the X-ray imaging device 100 according to an example of the first embodiment and a threshold value of a TFT of the X-ray imaging device according to a comparative example.

FIG. 11 is a diagram illustrating a configuration of a switch unit 520 according to a modified example of the first embodiment.

FIG. 12 is a diagram illustrating a configuration of a gate drive circuit 614 according to a first modified example of the second embodiment.

FIG. 13 is a diagram illustrating a configuration of a switch unit 720 according to a second modified example of the third embodiment.

FIG. 14 is a diagram illustrating a configuration of a photoelectric conversion panel 801 according to a second modified example of the second embodiment.

FIG. 15 is a diagram illustrating a configuration of a photoelectric conversion panel 901 according to a third modified example of the second embodiment.

### DESCRIPTION OF EMBODIMENTS

Embodiments of the disclosure will be described below with reference to the drawings. Note that the disclosure is not limited to the following embodiments, and appropriate design changes can be made within a scope that satisfies the configuration of the disclosure. In the description below, the same reference signs are used in common among the different drawings for portions having the same or similar functions, and repeated description thereof will be omitted. Further, the configurations described in the embodiments and the modified examples may be combined or modified as appropriate within a range that does not depart from the gist of the disclosure. For ease of explanation, in the drawings referenced below, the configuration is simplified or schematically illustrated, or a portion of the components is omitted. Further, dimensional ratios between components illustrated in the drawings are not necessarily indicative of actual dimensional ratios.

### First Embodiment

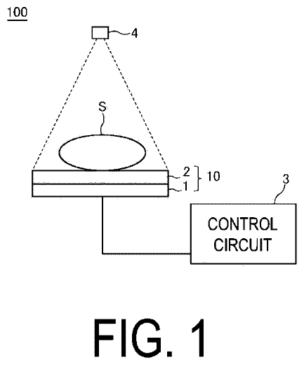

FIG. 1 is a schematic view illustrating an X-ray imaging device 100 according to a first embodiment. The X-ray imaging device 100 includes an X-ray imaging panel 10. The X-ray imaging panel 10 includes a photoelectric conversion panel 1 and a scintillator 2 disposed to overlap the photoelectric conversion panel 1. Further, the X-ray imaging device 100 includes a control circuit 3 and an X-ray source 4. The X-ray source 4 irradiates a subject S with X-rays. X-rays passing through the subject S are converted into light (hereinafter, referred to as “scintillation light”) in the scintillator 2 disposed at an upper portion of the photoelectric conversion panel 1. The X-ray imaging device 100 obtains an X-ray image by the control circuit 3 by imaging the scintillation light with the X-ray imaging panel 10.

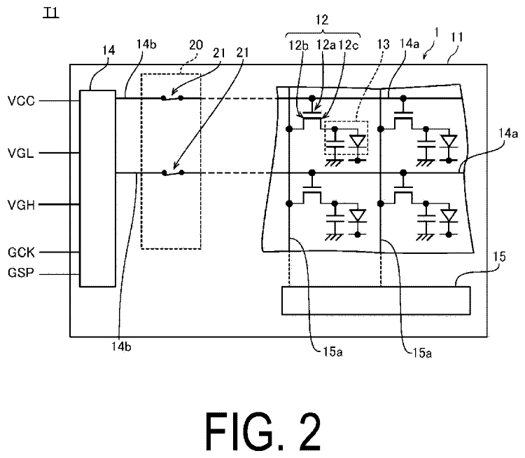

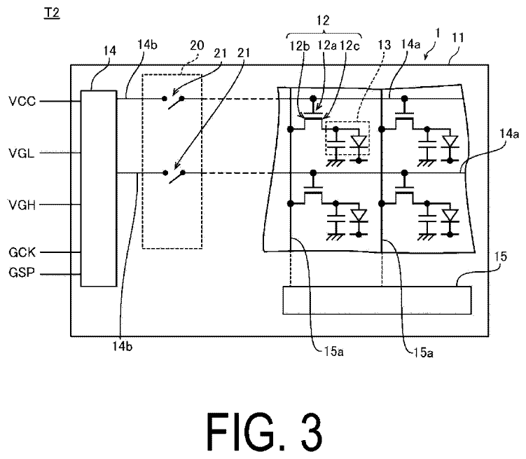

FIGS. 2 and 3 are schematic circuit diagrams of the X-ray imaging device 100 according to the first embodiment. As illustrated in FIG. 2, the photoelectric conversion panel 1 includes a substrate 11. A thin film transistor (TFT) 12, a photoelectric conversion element 13, a gate drive circuit 14, and a data reading circuit 15 are disposed on the substrate 11. Each of the gate drive circuit 14 and the data reading circuit 15 may be configured as an integrated circuit (IC) or may be monolithically formed in the substrate 11 (integrally formed with the substrate 11). The photoelectric conversion element 13 is configured by, for example, a photodiode. In addition, for example, as illustrated in FIG. 1, the control circuit 3 is disposed on a substrate different from the substrate 11, and is connected to the gate drive circuit 14 and the data reading circuit 15 by a wiring line or a flexible printed circuit board.

A plurality of source wiring lines 15a (data wiring lines) and a plurality of gate lines 14a intersecting the plurality of source wiring lines 15a are formed on the substrate 11. The gate line 14a is connected to a gate electrode 12a of the TFT 12. The source wiring line 15a is connected to the data reading circuit 15 and a source electrode 12b of the TFT 12. The TFT 12 and the photoelectric conversion element 13 are disposed in a region (pixel) surrounded by the source wiring line 15a and the gate line 14a. The photoelectric conversion element 13 converts the scintillation light into electric charges depending on a light amount of the scintillation light.

The gate drive circuit 14 outputs a gate signal to the gate electrode 12a of the TFT 12 based on a control signal received from the control circuit 3. the gate signal is sequentially output from the gate drive circuit 14 to each gate line 14a in the photoelectric conversion panel 1. The TFT 12 includes the gate electrode 12a, the source electrode 12b, and a drain electrode 12c. The TFT 12 includes an In—Ga—Zn—0 based oxide semiconductor. In detail, as the oxide semiconductor, InGaO₃(ZnO)₅, magnesium zinc oxide (MgxZn₁₋ₓO), cadmium zinc oxide (CdxZn₁₋ₓO), cadmium oxide (CdO), an amorphous oxide semiconductor containing indium (In), gallium (Ga), and zinc (Zn) in a predetermined ratio, or the like may be used. The drain electrode 12c is connected to the photoelectric conversion element 13. When the gate signal having a voltage equal to or higher than a threshold value Vth is applied to the gate electrode 12a, the TFT 12 enters an on state (a state in which the TFT 12 is brought into conduction). That is, the TFT 12 according to the first embodiment is a normally-off thin film transistor.

When the TFT 12 is in the on state, a signal corresponding to electric charges converted by the photoelectric conversion element 13 is output to the data reading circuit 15 through the source wiring line 15a. The data reading circuit 15 amplifies the signal corresponding to the electric charges converted by the photoelectric conversion element 13 and transmits the amplified signal to the control circuit 3. The control circuit 3 generates an X-ray captured image based on the signal obtained from the data reading circuit 15.

As illustrated in FIG. 2, a gate start pulse signal GSP and a gate clock signal GCK are input from the control circuit 3 to the gate drive circuit 14. The gate start pulse signal GSP is a signal for instructing the gate drive circuit 14 to start scanning. The gate clock signal GCK is a signal that becomes High level at a constant cycle. The gate drive circuit 14 includes a shift register. After the gate start pulse signal GSP is input, the shift register of the gate drive circuit 14 switches the output line 14b that outputs the gate signal each time the gate clock signal GCK is input. That is, the gate drive circuit 14 switches the gate line 14a that supplies the gate signal.

As illustrated in FIG. 2, a gate drive circuit power supply voltage VCC (hereinafter referred to as “power supply voltage VCC”), a gate-off voltage VGL, and a gate-on voltage VGH are applied to the gate drive circuit 14 from the control circuit 3. The power supply voltage VCC is a voltage having a constant voltage value for operating the gate drive circuit 14. The gate-off voltage VGL is a voltage having a constant voltage value less than the threshold value Vth of the TFT 12, and is a voltage for turning off the TFT 12. The gate-on voltage VGH is a voltage having a constant voltage value equal to or higher than the threshold value Vth of the TFT 12, and is a voltage for turning on the TFT 12. The gate-on voltage VGH is a voltage having a voltage value higher than that of the gate-off voltage VGL. Note that “outputs the gate signal” or “supplies the gate signal” means applying the gate-on voltage VGH.

As illustrated in FIG. 2, the gate drive circuit 14 is connected to the output lines 14b that are of the same number as the number of the gate lines 14a. The photoelectric conversion panel 1 includes a switch unit 20. The switch unit 20 includes a plurality of switches 21. Each switch 21 is disposed between a respective one of the plurality of gate lines 14a and a respective one of the plurality of output lines 14b. The switch 21 switches between a state in which the gate line 14a and the output line 14b are connected to each other (see FIG. 2) and a state in which the gate line 14a and the output line 14b are disconnected from each other (see FIG. 3) according to an instruction from the control circuit 3. The output line 14b enters a floating state when in a state of being disconnected from the gate line 14a by the switch 21. The “floating state” means a state in which a conductor (wiring line) is not connected to a wiring line or the like having a predetermined potential and a potential of the conductor (wiring line) is not maintained at a fixed value. Thus, in the state where the gate line 14a and the output line 14b are disconnected from each other, the gate electrode 12a of the TFT 12 is in the floating state.

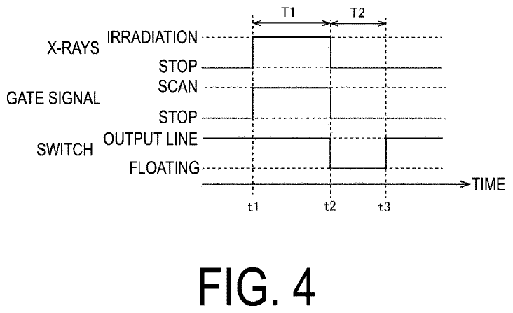

FIG. 4 is a diagram for describing a period T1 during which X-rays are emitted and an operation timing of the switch 21 according to the first embodiment. As illustrated in FIG. 4, X-rays are emitted from the X-ray source 4 during the period T1 from a time point t1 to a time point t2. In the photoelectric conversion panel 1, the gate signal is supplied to each TFT 12 in the period T1, and the signal corresponding to electric charges converted by the photoelectric conversion element 13 is output to the data reading circuit 15 through the source wiring line 15a. In the period T1, all the switches 21 are in a state of connecting the gate line 14a and the output line 14b to each other. Then, at the time point t2 when the period T1 during which the X-rays are emitted ends, the control circuit 3 switches the switch 21. Thus, the gate line 14a and the output line 14b are in a state of being disconnected from each other, and the gate electrode 12a of the TFT 12 enters the floating state. The control circuit 3 sets the state in which the gate line 14a and the output line 14b are disconnected from each other by the switch 21 for a predetermined period T2 (from the time point t2 to the time point t3), and sets the state back in which the gate line 14a and the output line 14b are connected to each other by the switch 21 at a time point t3.

Here, when the TFT 12 is irradiated with X-rays in the period T1, holes are generated in the TFT 12 due to an ionization effect. When the gate-off voltage VGL is applied to the TFT 12, the generated holes are attracted to an interface between the semiconductor and a gate oxide film (gate insulating film) in the TFT 12 and are fixed (trapped) in an interface state. As a result, a positive charge is fixed to the interface, and the threshold value Vth of the TFT 12 negatively shifts (the threshold shift occurs). However, in the period T2 after the period T1, the gate electrode 12a of the TFT 12 is in the floating state, not at a potential of the gate-off voltage VGL. As a result, even when holes are generated in the TFT 12, since holes are not attracted to the interface, holes can be prevented from being fixed to the interface. In addition, even when holes are fixed to the interface, since holes are released from the interface as time elapses in the period T2, the threshold value of the negatively shifted TFT 12 is recovered. Thus, even when the photoelectric conversion panel 1 includes the normally-off TFT 12 and the threshold shift occurs, the threshold shift can be reduced. In addition, unlike a case where the switch 21 is connected to the ground, a wiring line from the switch 21 to the ground is not necessary according to the above-described configuration. In addition, not only the wiring line to the ground is not necessary but also a contact for ground connection is not necessary, and thus the circuit of the switch 21 can be further simply configured (for example, the switch 21 can be configured as a two terminal switch instead of a three terminal switch).

### Second Embodiment

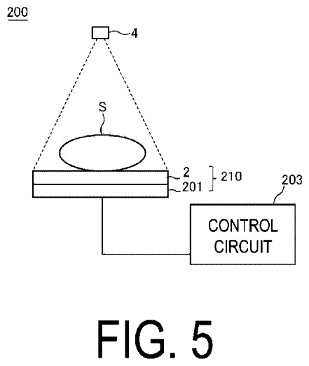

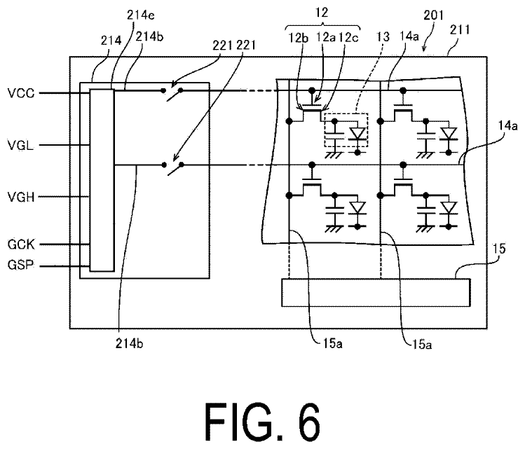

Next, a configuration of an X-ray imaging device 200 according to a second embodiment will be described with reference to FIGS. 5 and 6. In the second embodiment, switches 221 are disposed in a gate drive circuit 214. Note that the same configurations as those of the first embodiment will be denoted by the same reference signs as those of the first embodiment, and descriptions thereof will be omitted.

FIG. 5 is a view illustrating a configuration of the X-ray imaging device 200 according to the second embodiment. FIG. 6 is a diagram illustrating a configuration of a photoelectric conversion panel 201 according to the second embodiment. As illustrated in FIG. 5, the X-ray imaging device 200 includes an X-ray imaging panel 210 and a control circuit 203. The X-ray imaging panel 210 includes the photoelectric conversion panel 201.

As illustrated in FIG. 6, the photoelectric conversion panel 201 includes a substrate 211 and the gate drive circuit 214. The gate drive circuit 214 is disposed on the substrate 211. In the second embodiment, the gate drive circuit 214 includes a shift register 214e and a plurality of the switches 221. The gate drive circuit 214 includes a plurality of output lines 214b that outputs gate signals. After the gate start pulse signal GSP is input, the shift register 214e switches the output line 14b that outputs the gate signal each time the gate clock signal GCK is input. The switch 221 is disposed between the shift register 214e and the gate line 14a. Further, the switch 221 is connected between the output line 214b and the gate line 14a. The control circuit 203 transmits a signal for controlling the switch 221 to the gate drive circuit 214. In the period T1 (see FIG. 4), the control circuit 203 sets a state in which the output line 214b and the gate line 14a are connected to each other by the switch 221. In addition, the control circuit 203 operates the switch 221 so as to disconnect the output line 214b and the gate line 14a from each other in the period T2 (see FIG. 4) that is at least part of a period during which X-rays are not emitted from the X-ray source 4. Thus, in the period T2, the gate line 14a enters the floating state.

According to the second embodiment, unlike the case where the switch is disposed away from the gate drive circuit, it is possible to prevent a path (wiring line) that connects the switch 221 and the output line 214b to each other from becoming long. Other configurations and effects of the second embodiment are the same as the configurations and effects of the first embodiment.

### Third Embodiment

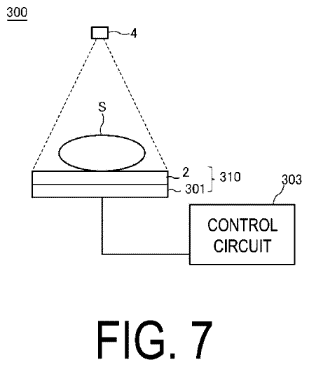

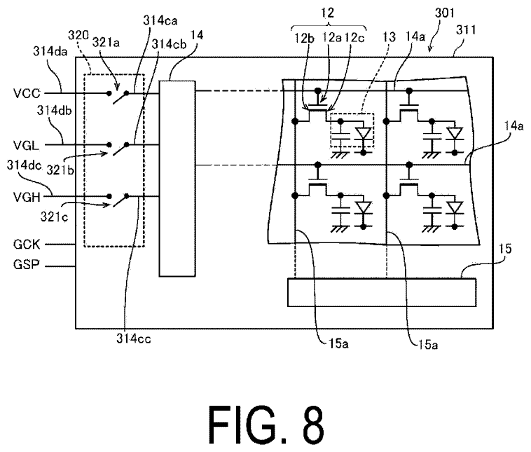

Next, a configuration of an X-ray imaging device 300 according to a third embodiment will be described with reference to FIGS. 7 and 8. In the third embodiment, the switch 321 is connected to an input line 314c of a gate drive circuit 314. Note that the same configurations as those of the first embodiment will be denoted by the same reference signs as those of the first embodiment, and descriptions thereof will be omitted.

FIG. 7 is a view illustrating a configuration of the X-ray imaging device 300 according to the third embodiment. FIG. 8 is a diagram illustrating a configuration of a photoelectric conversion panel 301 according to the third embodiment. As illustrated in FIG. 7, the X-ray imaging device 300 includes an X-ray imaging panel 310 and a control circuit 303. The X-ray imaging panel 310 includes the photoelectric conversion panel 301.

As illustrated in FIG. 8, the photoelectric conversion panel 301 includes a substrate 311 and a switch unit 320. The switch unit 320 is disposed on the substrate 311. Input lines 314ca to 314cc are connected to the gate drive circuit 14. A voltage line 314da to which the power supply voltage VCC supplied from the control circuit 303 is applied, a voltage line 314db to which the gate-off voltage VGL supplied from the control circuit 303 is applied, and a voltage line 314dc to which the gate-on voltage VGH supplied from the control circuit 303 is applied are disposed on the substrate 311.

In the third embodiment, the switch unit 320 includes a switch 321a disposed between the input line 314ca and the voltage line 314da, a switch 321b disposed between the input line 314cb and the voltage line 314db, and a switch 321c disposed between the input line 314cc and the voltage line 314dc. The control circuit 303 brings the switches 321a to 321c into an on state in the period T1 (see FIG. 4), and brings the switches 321a to 321c into an off state in the period T2 (see FIG. 4) that is at least part of the period during which X-rays are not emitted from the X-ray source 4. Thus, in the period T1, the voltage line 314da and the input line 314ca are connected to each other, the voltage line 314db and the input line 314cb are connected to each other, and the voltage line 314dc and the input line 314cc are connected to each other. In the period T2, the voltage line 314da and the input line 314ca are disconnected from each other, the voltage line 314db and the input line 314cb are disconnected from each other, and the voltage line 314dc and the input line 314cc are disconnected from each other. Thus, potentials of the input lines 314ca to 314cc are in the floating state.

Here, in the period T2, the gate drive circuit 14 supplies a potential of the input line 314ca to the plurality of gate lines 14a. That is, in the period T2, the input line 314ca in the floating state and the plurality of gate lines 14a are connected to each other. As a result, the plurality of gate lines 14a enter the floating state.

Also according to the third embodiment, since the gate electrode 12a of the TFT 12 is in the floating state, not at the potential of the gate-off voltage VGL, even when holes are generated in the TFT 12, holes are not attracted to the interface. As a result, holes can be prevented from being fixed to the interface. In addition, even when holes are fixed to the interface, since holes are released from the interface as time elapses, the threshold value of the negatively shifted TFT 12 is recovered. Thus, also in the third embodiment, even when the normally-off TFT 12 is included and the threshold shift occurs, the threshold shift can be reduced. Other configurations and effects of the third embodiment are the same as the configurations and effects of the first embodiment.

### First Modified Example of Third Embodiment

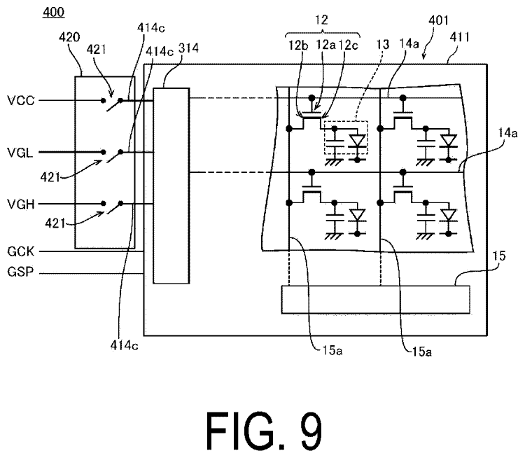

Next, a configuration of an X-ray imaging device 400 according to a first modified example of a third embodiment will be described with reference to FIG. 9. In the third embodiment, an example is illustrated in which the switch unit 320 is disposed on the substrate 311. However, in the first modified example of the third embodiment, a switch unit 420 including a plurality of switches 422 is disposed outside a substrate 411. For example, the switch unit 420 is disposed on a substrate on which the control circuit 303 (see FIG. 7) is disposed. Part of an input line 414c connecting the switch unit 420 and the gate drive circuit 314 to each other may be configured as a cable or may be configured as a flexible printed circuit board. The present embodiment is not limited to this example, and the input line 414c may be provided on a substrate on which only the switch unit 420 is disposed. Note that other configurations and effects of the first modified example of the third embodiment are the same as the configurations and effects of the third embodiment.

### Comparison Result Between Example According to First Embodiment and Comparative Example

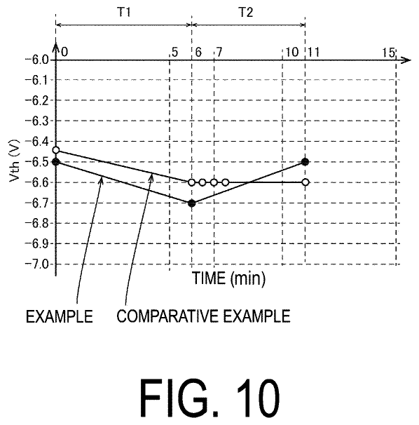

Next, the comparison result between the example according to the first embodiment and a comparative example will be described with reference to FIG. 10. FIG. 10 shows measurement results of a threshold value of the TFT 12 of the X-ray imaging device 100 according to the example of the first embodiment and a threshold value of a TFT of the X-ray imaging device according to the comparative example. In both the X-ray imaging device 100 according to the example of the first embodiment and the X-ray imaging device according to the comparative example, the length of the period T1 was set to 6 minutes, the period T2 was provided immediately after the period T1, and the length of the period T2 was set to 5 minutes. In the period T1, the gate drive circuit was driven while the photoelectric conversion panel was irradiated with X-rays from the X-ray source 4. In the X-ray imaging device 100 according to the example of the first embodiment, the gate line 14a was brought into the floating state in the period T2. In the X-ray imaging device according to the comparative example, the gate-off voltage VGL was applied to the gate line 14a in the period T2.

As shown in FIG. 10, in the comparative example, the threshold value was −6.44 V at a start point (0 min) of the period T1 and −6.60 V at an end point (6 min) of the period T1. In the period T2, the threshold value was −6.60 V from the start point (6 min) to the end point (11 min). That is, it was found that in the comparative example, the threshold value at the end point (11 min) of the period T2 was lower (negatively shifted) than the threshold value at the start point (0 min) of the period T1.

On the other hand, in the example, the threshold value was −6.50 V at the start point (0 min) of the period T1 and −6.70 V at the end point (6 min) of the period T1. In the period T2, the threshold value was −6.70 V at the start point (6 min) and −6.50 V at the end point (11 min). In addition, in the example, the threshold value at the end point (11 min) of the period T2 and the threshold value at the start point (0 min) of the period T1 coincide with each other. As a result, in the example, it was found that even when the threshold value was shifted by −0.2 V, the threshold value was increased by 0.2 V in the period T2, and the negative shift was recovered. In the X-ray imaging device 100 according to the first embodiment, even when the gate line 14a was connected to the ground during the period T2, the same results and effects as those of the above-described example were obtained.

Embodiments have been described above, but the embodiments described above are merely examples for implementing the disclosure. Thus, the disclosure is not limited to the embodiments described above and can be implemented by modifying the embodiments described above as appropriate without departing from the scope of the disclosure.

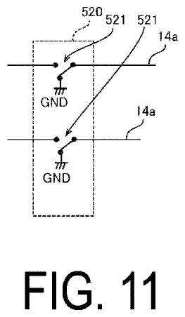

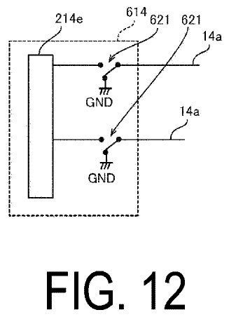

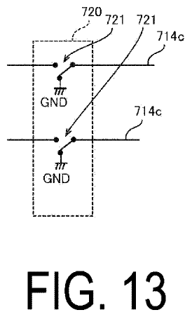

(1) In the above-described first to third embodiments, an example is illustrated in which the gate electrode 12a (gate line 14a) of the TFT 12 is brought into the floating state in the period T2 (see FIG. 4) that is part of the period during which X-rays are not emitted from the X-ray source 4. However, the disclosure is not limited thereto. For example, a switch 521 of a switch unit 520 according to a modified example of the first embodiment illustrated in FIG. 11, a switch 621 of a gate drive circuit 614 according to a first modified example of the second embodiment illustrated in FIG. 12, and a switch 721 of a switch unit 720 according to a second modified example of the third embodiment illustrated in FIG. 13 are configured to connect the gate line 14a to the ground (GND) in the period T2. Note that the switch 721 illustrated in FIG. 13 connects an input line 714c connected to the gate drive circuit to the ground in the period T2. In the period T2, the input line 714c is connected to the gate line 14a, so the gate electrode 12a (gate line 14a) of the TFT 12 is at the ground potential.

(2) In the first to third embodiments, as illustrated in FIG. 4, an example is illustrated in which the gate electrode 12a (gate line 14a) of the TFT 12 is brought into the floating state only in the period T2 that is part of the period during which X-rays are not emitted from the X-ray source 4. However, the disclosure is not limited thereto. The X-ray imaging device may be configured such that the gate electrode 12a (gate line 14a) of the TFT 12 is in the floating state or connected to the ground in all the periods other than the period T1.

(3) In the first to third embodiments, an example is illustrated in which the period T2 (the period during which the gate electrode 12a (the gate line 14a) is brought into the floating state or connected to the ground) is provided immediately after the period T1. However, the disclosure is not limited thereto. That is, the period T2 (a period during which the gate electrode 12a (the gate lines 14a) is brought into the floating state or connected to the ground) may be provided after a predetermined period has elapsed after the period T1.

(4) In the first to third embodiments, an example is illustrated in which the gate electrodes 12a (gate lines 14a) of all the TFTs 12 are brought into the floating state in the period T2. However, the disclosure is not limited thereto. That is, in the period T2, the gate electrodes 12a (gate line 14a) of part of the TFTs 12 of a plurality of the TFTs 12 may be brought into the floating state.

(5) In the third embodiment, an example is illustrated in which the switch 321a is provided between the voltage line 314da to which the power supply voltage VCC is applied and the input line 314ca, between the voltage line 314db to which the gate-off voltage VGL is applied and the input line 314cb, and between the voltage line 314dc to which the gate-on voltage VGH is applied and the input line 314cc. However, the disclosure is not limited thereto. For example, the switch 321a may be provided only between the voltage line 314db to which the gate-off voltage VGL is applied and the input line 314cb. However, in the method in which the switch 321a is provided only between the voltage line 314db to which the gate-off voltage VGL is applied and the input line 314cb, there is a possibility that an irregular input deviating from the specifications is performed depending on a type of the gate drive circuit (driver), and there is a possibility that the operation of the gate drive circuit becomes unstable (note that this method can be used in the case of being used within the specifications). On the other hand, in the third embodiment, since the switches are provided for all the power supply voltages, it is possible to prevent the operation of the gate drive circuit from becoming unstable.

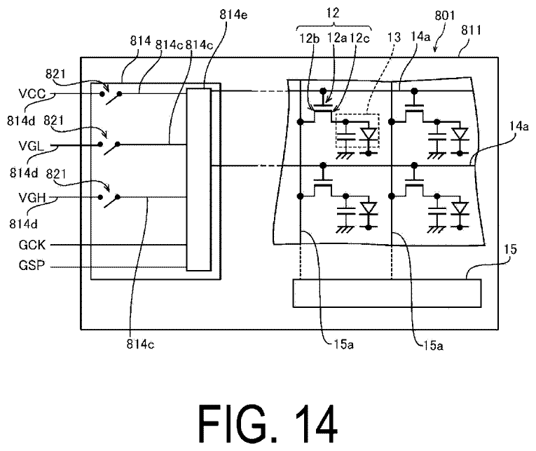

(6) In the second embodiment, an example is illustrated in which the switch 221 is provided between the output line 214b and the gate line 14a in the gate drive circuit 214. However, the disclosure is not limited thereto. For example, a photoelectric conversion panel 801 according to a second modified example of the second embodiment illustrated in FIG. 14 includes a gate drive circuit 814. In the gate drive circuit 814, a switch 821 is provided between a voltage line 814d to which the power supply voltage VCC is applied and a shift register 814e, between a voltage line 814d to which the gate-off voltage VGL is applied and the shift register 814e, and between a voltage line 814d to which the gate-on voltage VGH is applied and the shift register 814e. In this case, the switch 821 is connected between the voltage line 814d and the input line 814c.

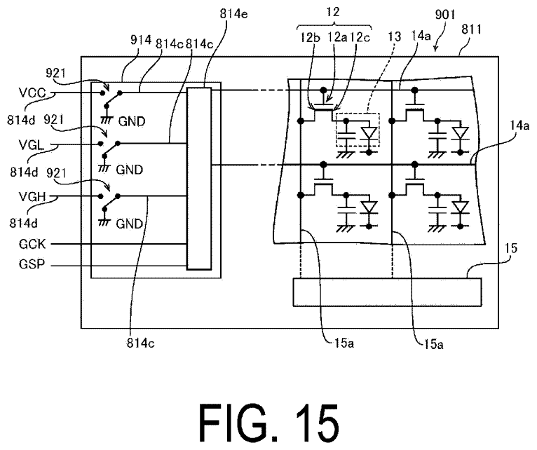

A photoelectric conversion panel 901 according to a third modified example of the second embodiment illustrated in FIG. 15 includes a gate drive circuit 914. The gate drive circuit 914 includes switches 921. The switch 921 of the gate drive circuit 914 is configured to connect the shift register 814e (input line 814c) to the ground (GND) in the period T2.

The X-ray imaging devices and the control method thereof described above may be described as in the following.

An X-ray imaging device according to a first configuration includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode, a gate line connected to the gate electrode, a gate drive circuit configured to supply the gate signal to the gate line, the gate drive circuit including an output line configured to output the gate signal, a switch connected between the gate line and the output line, and a control circuit configured to control an operation of the gate drive circuit and an operation of the switch, in which the control circuit operates the switch to switch from a state in which the gate line and the output line are connected to each other to a state in which the gate line is connected to a ground in a first period that is at least part of a period during which X-rays are not emitted from the X-ray source, or to switch from the state in which the gate line and the output line are connected to each other to a state in which the gate line and the output line are disconnected from each other in the first period (first configuration).

When the thin film transistor is irradiated with X-rays, holes are generated in the thin film transistor due to an ionization effect. When the gate-off voltage is applied to the thin film transistor, the generated holes are attracted to the interface between the semiconductor and a gate oxide film (gate insulating film) in the thin film transistor and are fixed (trapped) in an interface state. As a result, a positive charge is fixed to the interface, and the threshold value of the thin film transistor negatively shifts (the threshold shift occurs). On the other hand, according to the first configuration, the gate electrode of the thin film transistor is at the ground potential or in the floating state, not at the potential of the gate-off voltage in at least part of the period during which X-rays are not emitted from the X-ray source. As a result, even when holes are generated in the thin film transistor, since holes are not attracted to the interface, holes can be prevented from being fixed to the interface. In addition, even when holes are fixed to the interface, since holes are released from the interface as time elapses, the threshold value of the negatively shifted thin film transistor is recovered. Thus, even when the normally-off thin film transistor is included and the threshold shift occurs, the threshold shift can be reduced. Note that in the case where a normally-on thin film transistor is included, it is necessary to apply a voltage also to the bias electrode when 0 V is applied to the gate electrode. However, in the first configuration, since the thin film transistor is in the off state in the first period, it is not necessary to apply the voltage to the bias electrodes. In the case of the normally-on thin film transistor, when 0 V is applied to the gate electrode, the threshold value shifts in some cases. On the other hand, in the first configuration, as described above, the threshold shift of the thin film transistor can be reduced in the first period.

In the first configuration, the control circuit may be configured to operate the switch to connect the gate line to the ground or disconnect the gate line and the output line from each other in the first period after the period during which X-rays are emitted from the X-ray source ends (second configuration).

According to the second configuration, even when the threshold shift occurs in the thin film transistor in the period during which X-rays are emitted from the X-ray source, the threshold shift can be reduced immediately after the period.

In the first or second configuration, the control circuit may be configured to operate the switch to disconnect the gate line and the output line from each other in the first period (third configuration).

According to the third configuration, unlike the case where the gate line is connected to the ground, the wiring line for connecting the switch and the ground to each other is not necessary. In addition, not only the wiring line from the switch to the ground is not necessary but also a contact for ground connection is not necessary, and thus the circuit of the switch can be further simply configured (for example, the switch can be configured as a two terminal switch instead of a three terminal switch).

An X-ray imaging device according to a fourth configuration includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode, a gate line connected to the gate electrode, a gate drive circuit configured to supply the gate signal to the gate line, the gate drive circuit including an input line to which a gate-off voltage that is a voltage less than the threshold voltage is input, a gate-off voltage line configured to supply a gate-off voltage that is a voltage less than the threshold voltage to the input line, a switch connected between the gate-off voltage line and the input line, and a control circuit configured to control an operation of the gate drive circuit and an operation of the switch, in which the control circuit operates the switch to switch from a state in which the gate-off voltage line and the input line are connected to each other to a state in which the input line is connected to a ground in a second period that is at least part of a period during which X-rays are not emitted from the X-ray source, or to switch from the state in which the gate-off voltage line and the input line are connected to each other to a state in which the gate-off voltage line and the input line are disconnected from each other in the second period (fourth configuration).

According to the fourth configuration, the gate electrode of the thin film transistor is at the ground potential or in the floating state, not at the potential of the gate-off voltage in at least part of the period during which X-rays are not emitted from the X-ray source. As a result, even when holes are generated in the thin film transistor, since holes are not attracted to the interface, holes can be prevented from being fixed to the interface. In addition, even when holes are fixed to the interface, since holes are released from the interface as time elapses, the threshold value of the negatively shifted thin film transistor is recovered. Thus, even when the normally-off thin film transistor is included and the threshold shift occurs, the threshold shift can be reduced.

In the fourth configuration, the control circuit may be configured to operate the switch to connect the input line to the ground or disconnect the input line from the gate drive circuit in the second period after the period during which X-rays are emitted from the X-ray source ends (fifth configuration).

According to the fifth configuration, even when the threshold shift occurs in the thin film transistor in the period during which X-rays are emitted from the X-ray source, the threshold shift can be reduced immediately after the period.

In the fourth or fifth configuration, the control circuit may be configured to operate the switch to disconnect the input line from the gate drive circuit in the second period (sixth configuration).

According to the sixth configuration, unlike the case where the input line is connected to the ground, the wiring line for connecting the switch and the ground to each other is not necessary.

An X-ray imaging device according to the seventh configuration includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode of the thin film transistor, a gate line connected to the gate electrode, a gate drive circuit including a shift register configured to output the gate signal and a switch connected between the shift register and the gate line, and a control circuit configured to control an operation of the gate drive circuit. The control circuit operates the switch to switch from a state in which the shift register and the gate line are connected to each other to a state in which the gate line is connected to a ground in a third period that is at least part of a period during which X-rays are not emitted from the X-ray source, or to switch from the state in which the shift register and the gate line are connected to each other to a state in which the shift register and the gate line are disconnected from each other in the third period (seventh configuration). An X-ray imaging device according to the seventh configuration includes a scintillator configured to convert X-rays emitted from an X-ray source into light, a photoelectric conversion element configured to convert light from the scintillator into an electric signal, a thin film transistor connected to the photoelectric conversion element, the thin film transistor being turned on when a gate signal having a voltage equal to or higher than a threshold voltage is applied to a gate electrode of the thin film transistor, a gate line connected to the gate electrode, a gate-off voltage line configured to supply a gate-off voltage that is a voltage less than the threshold voltage, a gate drive circuit including a shift register configured to output the gate signal and a switch connected between the shift register and the gate-off voltage line, and a control circuit configured to control an operation of the gate drive circuit. The control circuit operates the switch to switch from a state in which the shift register and the gate-off voltage line are connected to each other to a state in which the shift register is connected to a ground in a fourth period that is at least part of a period during which X-rays are not emitted from the X-ray source, or to switch from the state in which the shift register and the gate-off voltage line are connected to each other to a state in which the shift register and the gate-off voltage line are disconnected from each other in the fourth period (eighth configuration).

According to the seventh configuration or the eighth configuration, unlike the case where the switch is disposed away from the gate drive circuit, it is possible to prevent the path (wiring line) that connects the switch and the gate drive circuit (output line or input line) to each other from becoming long.

The X-ray imaging devices and the control method thereof described above may be described as in the following supplements 1 to 8.

### Supplement 1

An X-ray imaging device including
a scintillator configured to convert X-rays emitted from an X-ray source into light,
a photoelectric conversion element configured to convert light from the scintillator into an electric signal,
a thin film transistor connected to the photoelectric conversion element, the thin film transistor being turned on when a gate signal having a voltage equal to or higher than a threshold voltage is applied to a gate electrode,
a gate line connected to the gate electrode,
a gate drive circuit configured to supply the gate signal to the gate line, the gate drive circuit including an output line configured to output the gate signal,
a switch connected between the gate line and the output line, and
a control circuit configured to control an operation of the switch, in which
the control circuit operates the switch to switch from a state in which the gate line and the output line are connected to each other to a state in which the gate line is connected to a ground in a first period that is at least part of a period during which X-rays are not emitted from the X-ray source, or to switch from the state in which the gate line and the output line are connected to each other to a state in which the gate line and the output line are disconnected from each other in the first period.

### Supplement 2

The X-ray imaging device according to supplement 1, in which
the first period is a period after a period during which X-rays are emitted from the X-ray source ends, and
the control circuit operates the switch to switch from the state in which the gate line and the output line are connected to each other to the state in which the gate line is connected to the ground in the period after the period during which X-rays are emitted from the X-ray source ends, or to switch from the state in which the gate line and the output line are connected to each other to the state in which the gate line and the output line are disconnected from each other in the period after the period during which X-rays are emitted from the X-ray source ends.

### Supplement 3

The X-ray imaging device according to supplement 1, in which the control circuit operates the switch to switch from the state in which the gate line and the output line are connected to each other to the state in which the gate line and the output line are disconnected from each other in the first period.

### Supplement 4

An X-ray imaging device including
a scintillator configured to convert X-rays emitted from an X-ray source into light,
a photoelectric conversion element configured to convert light from the scintillator into an electric signal,
a thin film transistor connected to the photoelectric conversion element, the thin film transistor being turned on when a gate signal having a voltage equal to or higher than a threshold voltage is applied to a gate electrode,
a gate line connected to the gate electrode,
a gate drive circuit configured to supply the gate signal to the gate line, the gate drive circuit including an input line to which a gate-off voltage that is a voltage less than the threshold voltage is input,
a gate-off voltage line configured to supply a gate-off voltage that is a voltage less than the threshold voltage to the input line,
a switch connected between the gate-off voltage line and the input line, and
a control circuit configured to control an operation of the switch, in which
the control circuit operates the switch to switch from a state in which the gate-off voltage line and the input line are connected to each other to a state in which the input line is connected to a ground in a second period that is at least part of a period during which X-rays are not emitted from the X-ray source, or to switch from the state in which the gate-off voltage line and the input line are connected to each other to a state in which the gate-off voltage line and the input line are disconnected from each other in the second period.

### Supplement 5

The X-ray imaging device according to supplement 4, in which
the second period is a period after a period during which X-rays are emitted from the X-ray source ends, and
the control circuit operates the switch to switch from the state in which the gate-off voltage line and the input line are connected to each other to the state in which the input line is connected to the ground in the period after the period during which X-rays are emitted from the X-ray source ends, or to switch from the state in which the gate-off voltage line and the input line are connected to each other to the state in which the gate-off voltage line and the input line are disconnected from each other in the period after the period during which X-rays are emitted from the X-ray source ends.

### Supplement 6

The X-ray imaging device according to supplement 4, in which the control circuit operates the switch to switch from the state in which the gate-off voltage line and the input line are connected to each other to the state in which the gate-off voltage line and the input line are disconnected from each other in the second period.

### Supplement 7

The X-ray imaging device according to supplement 1, in which the switch is disposed inside the gate drive circuit.

### Supplement 8

The X-ray imaging device according to supplement 4, in which the switch is disposed inside the gate drive circuit.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An X-ray imaging device comprising:
a scintillator configured to convert X-rays emitted from an X-ray source into light;
a photoelectric conversion element configured to convert light from the scintillator into an electric signal;
a thin film transistor connected to the photoelectric conversion element, the thin film transistor being turned on when a gate signal having a voltage equal to or higher than a threshold voltage is applied to a gate electrode;
a gate line connected to the gate electrode;
a gate drive circuit configured to supply the gate signal to the gate line, the gate drive circuit including an output line configured to output the gate signal;
a switch connected between the gate line and the output line; and
a control circuit configured to control an operation of the switch,
wherein the control circuit operates the switch to switch from a state in which the gate line and the output line are connected to each other to a state in which the gate line is connected to a ground in a first period that is at least part of a period during which X-rays are not emitted from the X-ray source, or to switch from the state in which the gate line and the output line are connected to each other to a state in which the gate line and the output line are disconnected from each other in the first period.

2. The X-ray imaging device according to claim 1,
wherein the first period is a period after a period during which X-rays are emitted from the X-ray source ends, and
the control circuit operates the switch to switch from the state in which the gate line and the output line are connected to each other to the state in which the gate line is connected to the ground in the period after the period during which X-rays are emitted from the X-ray source ends, or to switch from the state in which the gate line and the output line are connected to each other to the state in which the gate line and the output line are disconnected from each other in the period after the period during which X-rays are emitted from the X-ray source ends.

3. The X-ray imaging device according to claim 1,
wherein the control circuit operates the switch to switch from the state in which the gate line and the output line are connected to each other to the state in which the gate line and the output line are disconnected from each other in the first period.

4. An X-ray imaging device comprising:
a scintillator configured to convert X-rays emitted from an X-ray source into light;
a photoelectric conversion element configured to convert light from the scintillator into an electric signal;
a thin film transistor connected to the photoelectric conversion element, the thin film transistor being turned on when a gate signal having a voltage equal to or higher than a threshold voltage is applied to a gate electrode;
a gate line connected to the gate electrode;
a gate drive circuit configured to supply the gate signal to the gate line, the gate drive circuit including an input line to which a gate-off voltage that is a voltage less than the threshold voltage is input;
a gate-off voltage line configured to supply a gate-off voltage that is a voltage less than the threshold voltage to the input line;
a switch connected between the gate-off voltage line and the input line; and
a control circuit configured to control an operation of the switch,
wherein the control circuit operates the switch to switch from a state in which the gate-off voltage line and the input line are connected to each other to a state in which the input line is connected to a ground in a second period that is at least part of a period during which X-rays are not emitted from the X-ray source, or to switch from the state in which the gate-off voltage line and the input line are connected to each other to a state in which the gate-off voltage line and the input line are disconnected from each other in the second period.

5. The X-ray imaging device according to claim 4,
wherein the second period is a period after a period during which X-rays are emitted from the X-ray source ends, and
the control circuit operates the switch to switch from the state in which the gate-off voltage line and the input line are connected to each other to the state in which the input line is connected to the ground in the period after the period during which X-rays are emitted from the X-ray source ends, or to switch from the state in which the gate-off voltage line and the input line are connected to each other to the state in which the gate-off voltage line and the input line are disconnected from each other in the period after the period during which X-rays are emitted from the X-ray source ends.

6. The X-ray imaging device according to claim 4,
wherein the control circuit operates the switch to switch from the state in which the gate-off voltage line and the input line are connected to each other to the state in which the gate-off voltage line and the input line are disconnected from each other in the second period.

7. The X-ray imaging device according to claim 1, wherein the switch is disposed inside the gate drive circuit.

8. The X-ray imaging device according to claim 4, wherein the switch is disposed inside the gate drive circuit.
